(19) United States
(12) Patent Application Publication
(10) Pub. No.: US 2017/0278047 A1
(43) Pub. Date: Sep. 28, 2017

(54) DYNAMIC TASK INTERLEAVING IN ROBOT ASSISTED ORDER-FULFILLMENT OPERATIONS

(71) Applicant: LOCUS ROBOTICS CORPORATION, Andover, MA (US)

(72) Inventors: Bruce Welty, Boston, MA (US); Mike Johnson, Ashland, MA (US); Sean Johnson, Danvers, MA (US); Albert Arch Dekin, III, Lexington, MA (US)

(21) Appl. No.: 15/080,862

(22) Filed: Mar. 25, 2016

(51) Int. Cl. G06Q 10/08; G05D 1/00; B65G 1/04

(52) U.S. Cl. CPC G06Q 10/087; B65G 1/0492; G05D 1/0011; Y10S 901/01

(57) ABSTRACT

A method for executing an order to perform a plurality of tasks on items at locations throughout a warehouse space using a robot includes receiving an order for the robot to execute a plurality of tasks. The order including for each task, a task type and an item associated with each task. The method also includes navigating the robot to the locations in the warehouse space associated with each item and executing at each location, the task type on the associated item. The task types for the order include picking, placing, and at least one inventory control task.

### CROSS REFERENCE TO RELATED APPLICATION

This application claims the benefit of the priority date of U.S. application Ser. No. 14/815,246, filed on Jul. 31, 2015, the contents of which are incorporated herein by reference in their entirety.

### FIELD OF INVENTION

This invention relates to robot-assisted product order-fulfillment systems and methods and more particularly to such systems and methods in which robots dynamically perform multiple types of tasks, including picking and placing as well as inventory control tasks, in an interleaved manner.

### BACKGROUND

Ordering products over the internet for home delivery is an extremely popular way of shopping. Fulfilling such orders in a timely, accurate and efficient manner is logistically challenging to say the least. Clicking the “check out” button in a virtual shopping cart creates an “order.” The order includes a listing of items that are to be shipped to a particular address. The process of “fulfillment” involves physically taking or “picking” these items from a large warehouse, packing them, and shipping them to the designated address. An important goal of the order-fulfillment process is thus to ship as many items in as short a time as possible.

The order-fulfillment process typically takes place in a large warehouse that contains many products, including those listed in the order. Among the tasks of order fulfillment is therefore that of traversing the warehouse to find and collect the various items listed in an order. In addition, the products that will ultimately be shipped first need to be received in the warehouse and stored or “placed” in storage bins in an orderly fashion throughout the warehouse so they can be readily retrieved for shipping.

In a large warehouse, the goods that are being delivered and ordered can be stored in the warehouse very far apart from each other and dispersed among a great number of other goods. With an order-fulfillment process using only human operators to place and pick the goods requires the operators to do a great deal of walking and can be inefficient and time consuming. Since the efficiency of the fulfillment process is a function of the number of items shipped per unit time, increasing time reduces efficiency.

Typically, on a given “round trip” to execute an order from a warehouse management system, a robot will undertake a single function at multiple stops. For example, a robot may be assigned to “pick” a number of items dispersed throughout the warehouse and return the picked items to a packing station. At the packing station are operators who receive the items, package them and ship them to customers.

Similarly, a robot may be assigned to “place” a number of items in various locations dispersed throughout the warehouse. In performing this function, the robot would begin at an operator station and be loaded with items and instructions regarding the locations of the items to be stored in the warehouse. The robot would make its round trip dropping off items and then return to the operator station. On a given round trip throughout the warehouse to execute an order, a robot is typically assigned a single function, i.e. picking or placing of item.

In addition to picking and placing products in the order-fulfillment warehouse, there are other tasks that are required to be performed. These include inventory control tasks such as consolidation, counting, verification, inspection and clean-up of products, which are performed manually by human operators. These tasks are labor intensive, require significant planning, and are typically very inefficient.

Therefore, careful planning and assignment of robot and operator resources is required in order perform the various functions required for a product fulfillment warehouse. This of course, can be very complex and challenging and result in less than optimal efficiency in warehouse operations.

### SUMMARY

In one aspect the invention features a method for executing an order to perform a plurality of tasks on items at locations throughout a warehouse space using a robot. The method includes receiving an order for the robot to execute a plurality of tasks, the order including for each task, a task type and an item associated with each task. The method also includes navigating the robot to the locations in the warehouse space associated with each item; and executing at each location, the task type on the associated item. The task types for the order include picking, placing, and at least one inventory control task.

In other aspects of the invention, one or more of the following features may be included. At least one inventory control task may be selected from the group consisting of consolidating, counting, verifying, cleaning, and inspecting. Each item may be associated with a fiducial marker in the warehouse space and each fiducial marker may be located proximate its respective item. The step of navigating may include obtaining a fiducial identification associated with each item and correlating each said fiducial identification with a corresponding fiducial marker. The step of navigating may further include obtaining a set of coordinates representing a position of the fiducial marker in the warehouse associated with each item. The step of navigating may include navigating the robot sequentially to each set of coordinates in the warehouse corresponding to the fiducial marker associated with each of the items.

In yet other aspects of the invention, one or more of the following features may be included. The step of executing may include communicating by the robot to a human operator proximate each location, the task type and the item on which the task is to be performed. The step of executing may further include communicating by the human operator to the robot the completion of the task. The method may further include producing the order by a warehouse management system. The step of producing the order may comprise selecting one of a pick task or a place task from a task queue, selecting the other of the pick task or the place task from the task queue, and selecting an inventory management task from the task queue. The other of the pick task or the place task and inventory the management task may be associated with the selected pick task or place task according to predetermined criteria. The step of producing the order may also comprise aggregating the selected pick task, place task and inventory management task to produce the order and transmitting the order to the robot for execution.

In another aspect the invention features a robot configured to execute an order to perform tasks on a plurality of items at locations throughout a warehouse space. The robot includes a mobile base and a processor configured to receive an order for the robot to execute a plurality of tasks, the order including for each task, a task type and an item associated with each task. The processor is also configured to navigate the robot to the locations in the warehouse space associated with each item and execute at each location, the task type on the associated item. The task types for the order include picking, placing, and at least one inventory control task.

In certain other aspects of the invention, one or more of the following features may be included. The inventory control task may be selected from the group consisting of consolidating, counting, verifying, cleaning, and inspecting. Each item may be associated with a fiducial marker in the warehouse space, each fiducial marker located proximate its respective item. The processor may be further configured to obtain a fiducial identification associated with each of item and correlate each fiducial identification with a corresponding fiducial marker. The processor may be configured to obtain a set of coordinates representing a position of the fiducial marker in the warehouse associated with each item and the processor may be further configured to navigate the robot sequentially to each set of coordinates in the warehouse corresponding to the fiducial marker associated with each of items.

In yet further other aspects of the invention the processor may be configured to cause the robot to communicate to a human operator proximate each location, the task type and the item on which the task is to be performed. The processor may be configured to allow the robot to receive communications from the human operator regarding the completion of each task. The order may be produced by a warehouse management system. The order may be produced by selecting one of a pick task or a place task from a task queue, selecting the other of the pick task or the place task from the task queue, and selecting an inventory management task from the task queue. The other of the pick task or the place task and inventory the management task may be associated with the selected pick task or place task according to predetermined criteria. The processor may be configured to aggregate the selected pick task, place task and inventory management task to produce the order.

In yet another aspect the invention features a method for executing an order to perform tasks on a plurality of items at locations throughout a warehouse space using a robot. The method comprises receiving an order for the robot to execute a plurality of tasks, the order including for each task, a task type and an item associated with each task. There are at least two different task types associated with the items. The method also includes determining the locations in the warehouse space associated with each of items, wherein each of the items is associated with a fiducial marker located proximate the location of its respective item in the warehouse space. The step of determining includes obtaining a set of coordinates representing the location of the fiducial marker in the warehouse associated with each of the items and navigating the robot to each of said locations in the warehouse space by navigating to the coordinates of the fiducial marker in the warehouse associated with each of items. The method also includes executing at each location the task associated with the item corresponding to the location.

These and other features of the invention will be apparent from the following detailed description and the accompanying figures, in which:

### BRIEF DESCRIPTION OF THE FIGURES

FIG. 1 is a top plan view of an order-fulfillment warehouse;

FIG. 2 is a perspective view of a base of one of the robots used in the warehouse shown in FIG. 1;

FIG. 3 is a perspective view of the robot in FIG. 2 outfitted with an armature and parked in front of a shelf shown in FIG. 1;

FIG. 4 is a partial map of the warehouse of FIG. 1 created using laser radar on the robot;

FIG. 5 is a flow chart depicting the process for locating fiducial markers dispersed throughout the warehouse and storing fiducial marker poses;

FIG. 6 is a table of the fiducial identification to pose mapping;

FIG. 7 is a table of the bin location to fiducial identification mapping;

FIG. 8 is a flow chart depicting product SKU to pose mapping process;

FIG. 9 is a top plan view of an order-fulfillment warehouse depicting the interleaved task approach according to this invention; and

FIG. 10 is a flow chart depicting the task aggregation process according to this invention.

### DETAILED DESCRIPTION

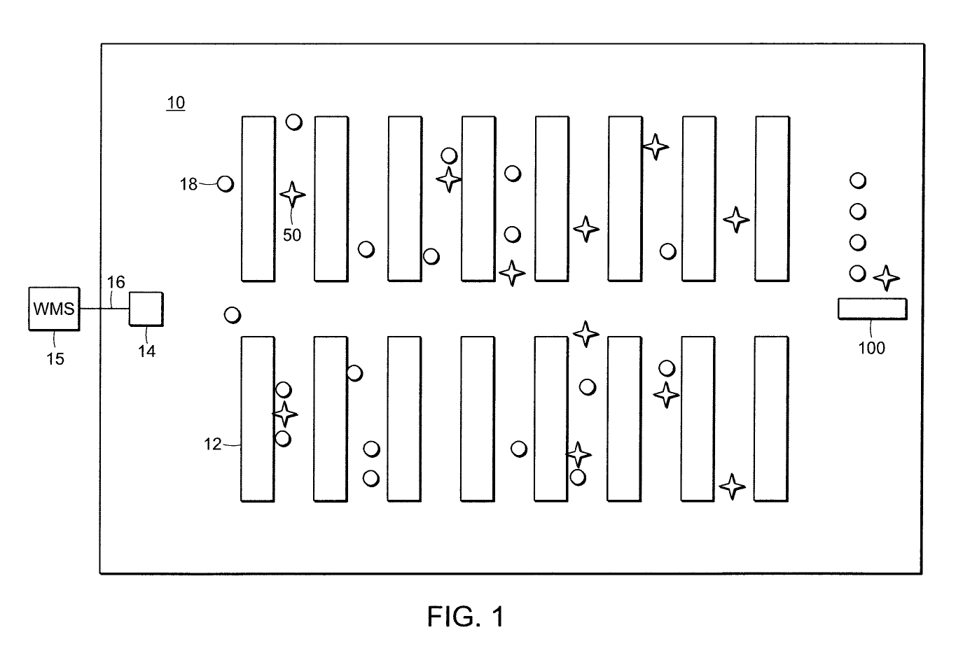

Referring to FIG. 1, a typical order-fulfillment warehouse 10 includes shelves 12 filled with the various items that could be included in an order 16. In operation, the order 16 from warehouse management server 15 arrives at an order-server 14. The order-server 14 communicates the order 16 to a robot 18 selected from a plurality of robots that roam the warehouse 10.

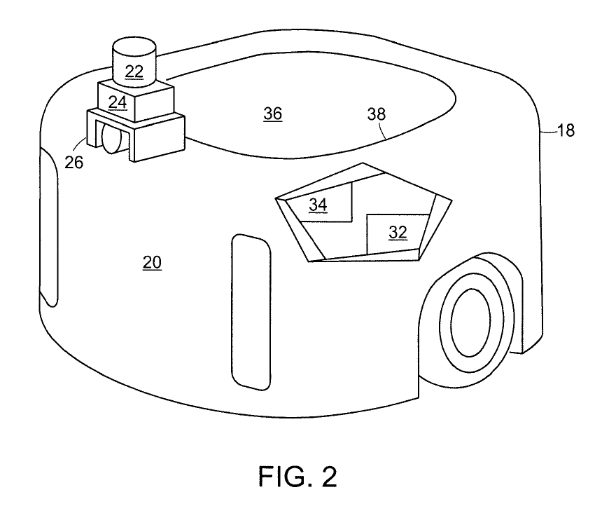

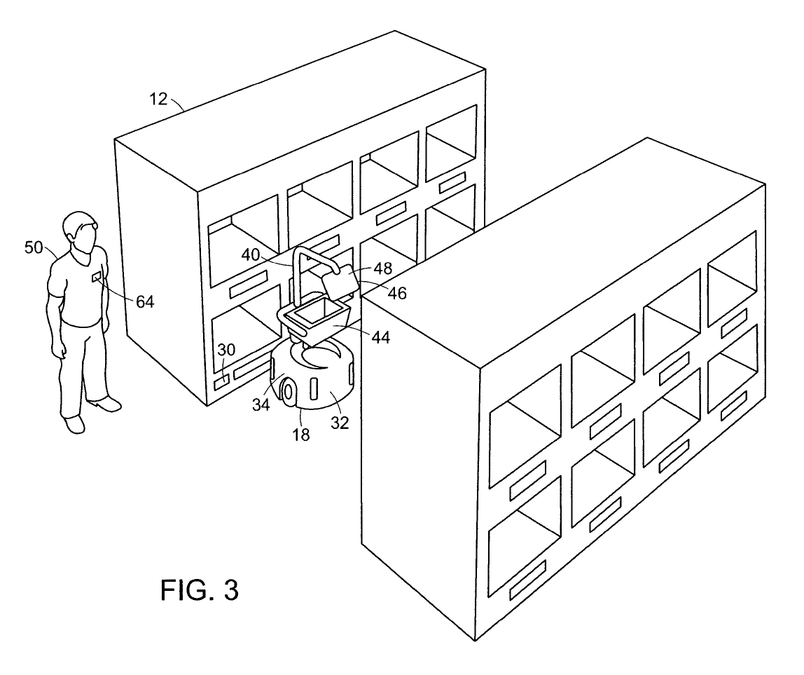

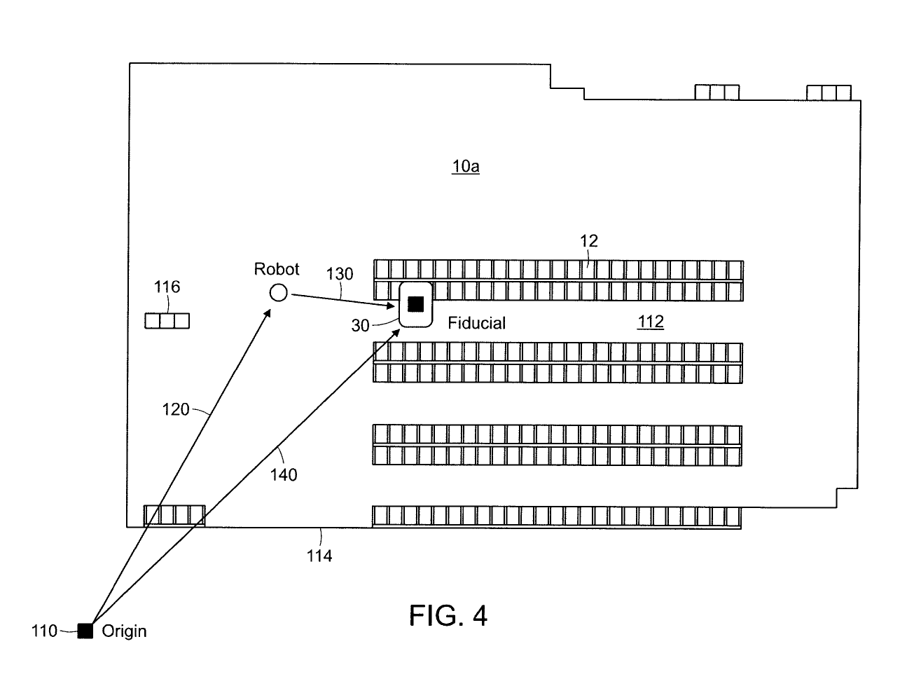

In a preferred embodiment, a robot 18, shown in FIG. 2, includes an autonomous wheeled base 20 having a laser-radar 22. The base 20 also features a transceiver 24 that enables the robot 18 to receive instructions from the order-server 14, and a camera 26. The base 20 also features a processor 32 that receives data from the laser-radar 22 and the camera 26 to capture information representative of the robot's environment and a memory 34 that cooperate to carry out various tasks associated with navigation within the warehouse 10, as well as to navigate to fiducial marker 30 placed on shelves 12, as shown in FIG. 3. Fiducial marker 30 (e.g. a two-dimensional bar code) corresponds to bin/location of an item ordered. The navigation approach of this invention is described in detail below with respect to FIGS. 4-8.

While the initial description provided herein is focused on picking items from bin locations in the warehouse to fulfill an order for shipment to a customer, the system is equally applicable to the storage or placing of items received into the warehouse in bin locations throughout the warehouse for later retrieval and shipment to a customer. The invention is also applicable to inventory control tasks associated with such a warehouse system, such as, consolidation, counting, verification, inspection and clean-up of products.

As described in more detail below, robots 18 can be utilized to perform multiple tasks of different task types in an interleaved fashion. This means that robot 18, while executing a single order traveling throughout the warehouse 10, may be picking items, placing items, and performing inventory control tasks. This kind of interleaved task approach can significantly improve efficiency and performance.

Referring again to FIG. 2, An upper surface 36 of the base 20 features a coupling 38 that engages any one of a plurality of interchangeable armatures 40, one of which is shown in FIG. 3. The particular armature 40 in FIG. 3 features a tote-holder 42 for carrying a tote 44 that receives items, and a tablet holder 46 for supporting a tablet 48. In some embodiments, the armature 40 supports one or more totes for carrying items. In other embodiments, the base 20 supports one or more totes for carrying received items. As used herein, the term “tote” includes, without limitation, cargo holders, bins, cages, shelves, rods from which items can be hung, caddies, crates, racks, stands, trestle, containers, boxes, canisters, vessels, and repositories.

Although a robot 18 excels at moving around the warehouse 10, with current robot technology, it is not very good at quickly and efficiently picking items from a shelf and placing them on the tote 44 due to the technical difficulties associated with robotic manipulation of objects. A more efficient way of picking items is to use a local operator 50, which is typically human, to carry out the task of physically removing an ordered item from a shelf 12 and placing it on robot 18, for example, in tote 44. The robot 18 communicates the order to the local operator 50 via the tablet 48, which the local operator 50 can read, or by transmitting the order to a handheld device used by the local operator 50.

Upon receiving an order 16 from the order server 14, the robot 18 proceeds to a first warehouse location, e.g. shown in FIG. 3. It does so based on navigation software stored in the memory 34 and carried out by the processor 32. The navigation software relies on data concerning the environment, as collected by the laser-radar 22, an internal table in memory 34 that identifies the fiducial identification (“ID”) of fiducial marker 30 that corresponds to a location in the warehouse 10 where a particular item can be found, and the camera 26 to navigate.

Upon reaching the correct location, the robot 18 parks itself in front of a shelf 12 on which the item is stored and waits for a local operator 50 to retrieve the item from the shelf 12 and place it in tote 44. If robot 18 has other items to retrieve it proceeds to those locations. The item(s) retrieved by robot 18 are then delivered to a packing station 100, FIG. 1, where they are packed and shipped.

It will be understood by those skilled in the art that each robot may be fulfilling one or more orders and each order may consist of one or more items. Typically, some form of route optimization software would be included to increase efficiency, but this is beyond the scope of this invention and is therefore not described herein.

In order to simplify the description of the invention, a single robot 18 and operator 50 are described. However, as is evident from FIG. 1, a typical fulfillment operation includes many robots and operators working among each other in the warehouse to fill a continuous stream of orders.

The navigation approach of this invention, as well as the semantic mapping of a SKU of an item to be retrieved to a fiducial ID/pose associated with a fiducial marker in the warehouse where the item is located, is described in detail below with respect to FIGS. 4-8.

Using one or more robots 18, a map of the warehouse 10 must be created and the location of various fiducial markers dispersed throughout the warehouse must be determined. To do this, one of the robots 18 navigates the warehouse and builds a map 10a, FIG. 4, utilizing its laser-radar 22 and simultaneous localization and mapping (SLAM), which is a computational problem of constructing or updating a map of an unknown environment. Popular SLAM approximate solution methods include the particle filter and extended Kalman filter. The SLAM GMapping approach is the preferred approach, but any suitable SLAM approach can be used.

Robot 18 utilizes its laser-radar 22 to create map 10a of warehouse 10 as robot 18 travels throughout the space identifying, open space 112, walls 114, objects 116, and other static obstacles, such as shelf 12, in the space, based on the reflections it receives as the laser-radar scans the environment.

While constructing the map 10a or thereafter, one or more robots 18 navigates through warehouse 10 using camera 26 to scan the environment to locate fiducial markers (two-dimensional bar codes) dispersed throughout the warehouse on shelves proximate bins, such as 32 and 34, FIG. 3, in which items are stored. Robots 18 use a known starting point or origin for reference, such as origin 110. When a fiducial marker, such as fiducial marker 30, FIGS. 3 and 4, is located by robot 18 using its camera 26, the location in the warehouse relative to origin 110 is determined.

By the use of wheel encoders and heading sensors, vector 120, and the robot's position in the warehouse 10 can be determined. Using the captured image of a fiducial marker/two-dimensional barcode and its known size, robot 18 can determine the orientation with respect to and distance from the robot of the fiducial marker/two-dimensional barcode, vector 130. With vectors 120 and 130 known, vector 140, between origin 110 and fiducial marker 30, can be determined. From vector 140 and the determined orientation of the fiducial marker/two-dimensional barcode relative to robot 18, the pose (position and orientation) defined by a quaternion (x, y, z, ω) for fiducial marker 30 can be determined.

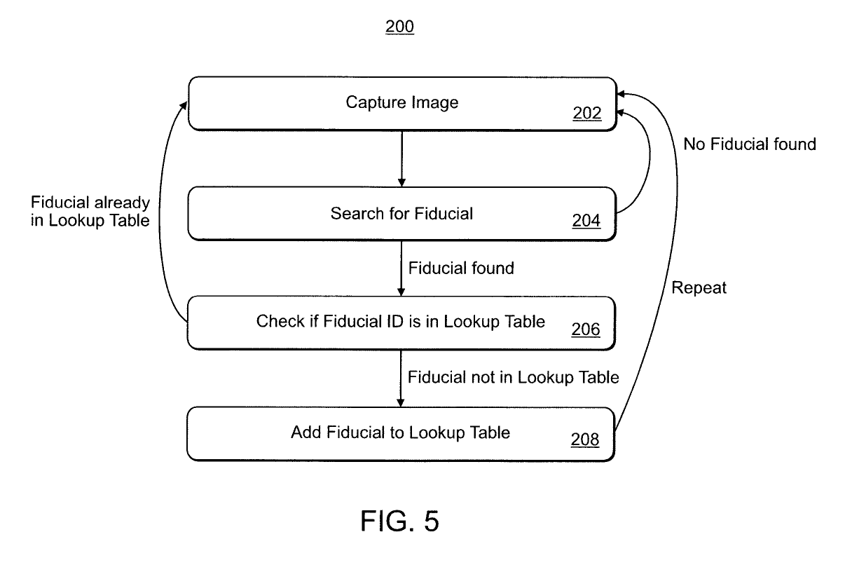

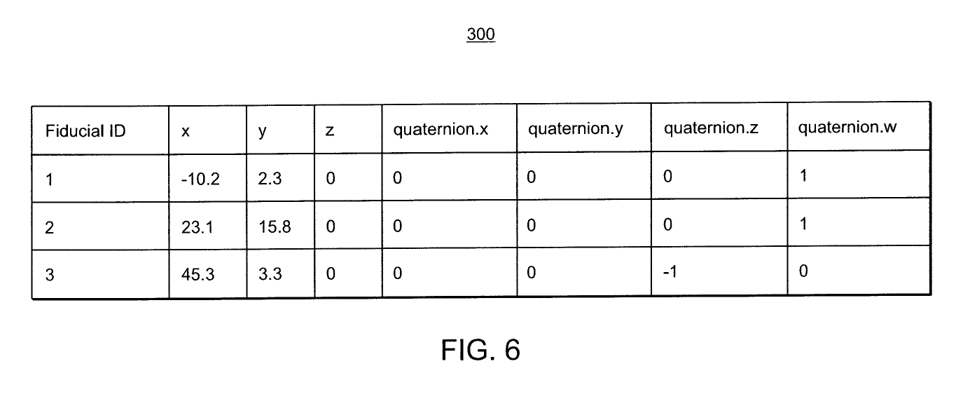

Flow chart 200, FIG. 5, describing the fiducial marker location process is described. This is performed in an initial mapping mode and as robot 18 encounters new fiducial markers in the warehouse while performing picking, placing and/or other tasks. In step 202, robot 18 using camera 26 captures an image and in step 204 searches for fiducial markers within the captured images. In step 206, if a fiducial marker is found in the image (step 204) it is determined if the fiducial marker is already stored in fiducial table 300, FIG. 6, which is located in memory 34 of robot 18. If the fiducial information is stored in memory already, the flow chart returns to step 202 to capture another image. If it is not in memory, the pose is determined according to the process described above and in step 208, it is added to fiducial to pose lookup table 300.

In look-up table 300, which may be stored in the memory of each robot, there are included for each fiducial marker a fiducial identification, 1, 2, 3, etc, and a pose for the fiducial marker/bar code associated with each fiducial identification. The pose consists of the x,y,z coordinates in the warehouse along with the orientation or the quaternion (x,y,z, ω).

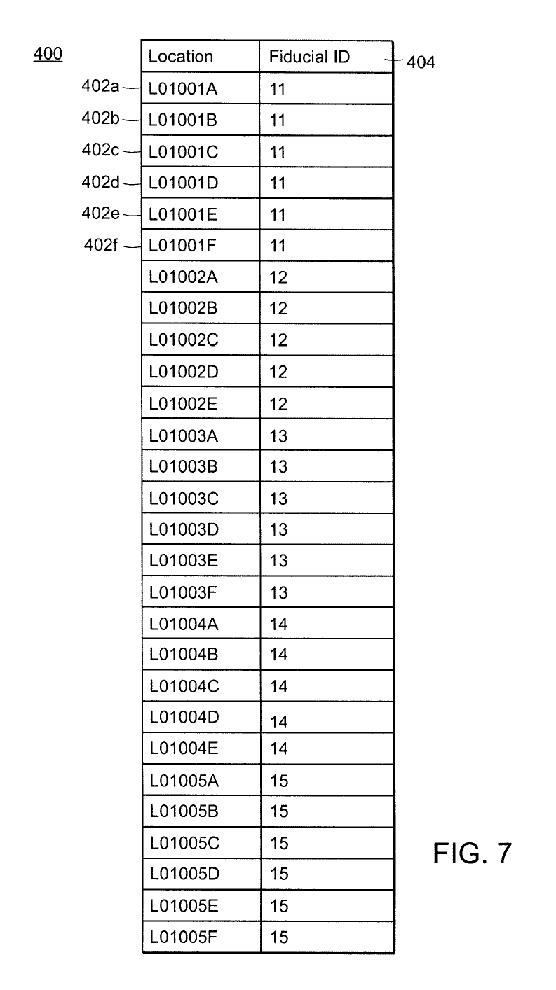

In another look-up Table 400, FIG. 7, which may also be stored in the memory of each robot, is a listing of bin locations (e.g. 402a-f) within warehouse 10, which are correlated to particular fiducial ID's 404, e.g. number “11”. The bin locations, in this example, consist of seven alpha-numeric characters. The first six characters (e.g. L01001) pertain to the shelf location within the warehouse and the last character (e.g. A-F) identifies the particular bin at the shelf location. In this example, there are six different bin locations associated with fiducial ID “11”. There may be one or more bins associated with each fiducial ID/marker.

The alpha-numeric bin locations are understandable to humans, e.g. operator 50, FIG. 3, as corresponding to a physical location in the warehouse 10 where items are stored. However, they do not have meaning to robot 18. By mapping the locations to fiducial ID's, Robot 18 can determine the pose of the fiducial ID using the information in table 300, FIG. 6, and then navigate to the pose as described herein.

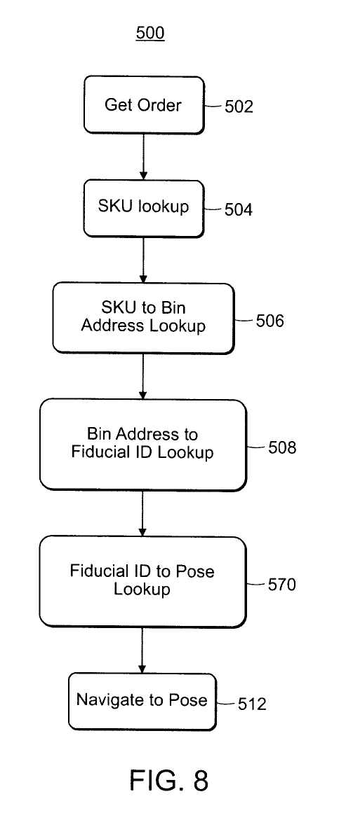

The order fulfillment process according to this invention is depicted in flow chart 500, FIG. 8. In step 502, warehouse management system 15, FIG. 1, obtains an order, which may consist of one or more items to be retrieved. In step 504 the SKU number(s) of the items is/are determined by the warehouse management system 15, and from the SKU number(s), the bin location(s) is/are determined in step 506. A list of bin locations for the order is then transmitted to robot 18. In step 508, robot 18 correlates the bin locations to fiducial ID's and from the fiducial ID's, the pose of each fiducial ID is obtained in step 510. In step 512 the robot 18 navigates to the pose as shown in FIG. 3, where an operator can pick the item to be retrieved from the appropriate bin and place it on the robot.

Item specific information, such as SKU number and bin location, obtained by the warehouse management system 15, can be transmitted to tablet 48 on robot 18 so that the operator 50 can be informed of the particular items to be retrieved when the robot arrives at each fiducial marker location.

With the SLAM map and the pose of the fiducial ID's known, robot 18 can readily navigate to any one of the fiducial ID's using various robot navigation techniques. The preferred approach involves setting an initial route to the fiducial marker pose given the knowledge of the open space 112 in the warehouse 10 and the walls 114, shelves (such as shelf 12) and other obstacles 116. As the robot begins to traverse the warehouse using its laser radar 26, it determines if there are any obstacles in its path either fixed or dynamic, such as other robots 18 and/or operators 50 and iteratively updates its path to the pose of the fiducial marker. The robot re-plans its route about once every 50 milliseconds, constantly searching for the most efficient and effective path while avoiding obstacles.

With the product SKU/fiducial ID to fiducial pose mapping technique combined with the SLAM navigation technique both described herein, robots 18 are able to very efficiently and effectively navigate the warehouse space without having to use more complex navigation approaches typically used which involve grid lines and intermediate fiducial markers to determine location within the warehouse.

As described above, certain robots and operators may be performing, in a dedicated way, placing or storage tasks to stock the warehouse with items. Human operators perform inventory control tasks such as consolidation of items, counting of items, verification, clean-up and inspection. These tasks are labor intensive, require significant planning, and are typically very inefficient.

However, in order to optimize usage of robots and operators and to increase efficiency and productivity of the overall order fulfillment warehouse operation, it is desirable to utilize the robots and operators in a multi-functional way during individual order sessions of the robots. That is, the robots may be used to perform different types of tasks (pick, place and inventory control tasks such as consolidation of items, counting of items, verification, clean-up and inspection) in an interleaved manner as they traverse the warehouse space executing an individual order session. This is distinct from the traditional dedicated functionality of a robot as it executes a single type of task during an order session.

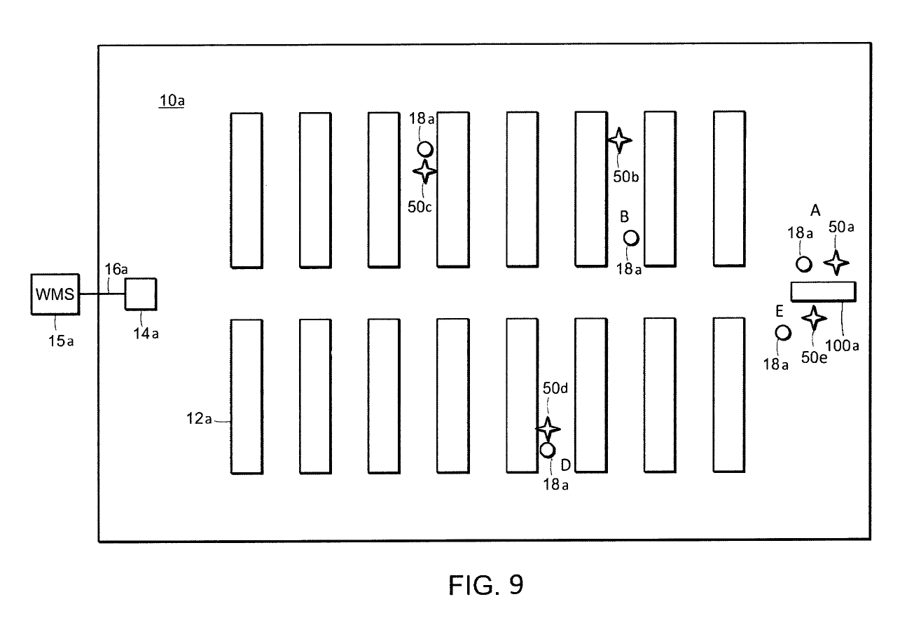

The interleaved task approach according to this invention is described with regard to FIG. 9. Similar to FIG. 1, a typical order-fulfillment warehouse 10a is shown to include shelves 12a filled with the various items. In operation, the order 16a from warehouse management server 15a arrives at an order-server 14a. In this case the order may include various tasks of different task types such picking, placing, and inventory control tasks for a robot to execute throughout the warehouse during an individual order session. The order-server 14a communicates the order 16a to a robot 18a selected from a plurality of robots that roam the warehouse 10.

In order to simplify this example, a single robot 18a executing three tasks of different task types in an individual order session is depicted. However, in a typical warehouse operation many robots would be operating in parallel and interacting with multiple operators. Moreover, an individual order session may include more than three tasks and the tasks may be of any task type.

Robot 18a is shown to be initially positioned at location A proximate station 100a where the robot is assigned its order to execute. Station 100a may be used as a packing station for orders picked from the warehouse to be packed and shipped to customers and it may also be used as a loading station for items received into the warehouse to be loaded on robots for storage in the warehouse. In this example, station 100a is configured to operate as both a packing and a loading station. As will be described below, Location E on the opposite side of station 100a, is where items to be packed for delivery to customers are received. It should be noted that two separate stations located at different places in warehouse 10a could also be used.

At Location A, operator 50a initiates the process by inducting robot 18a into the system (i.e. providing notification to WMS 15a that robot 18a is available to receive and execute an order session). In the induction process, the operator interacts with the robot 18a via the touch screen on the tablet of the robot or via a handheld wireless device to activate it. The robot then communicates to WMS 15a that it is ready to receive its order session. The operator also provides robot 18a with a tote. The tote may be empty, which would be the case for an order not including a pick task.

Alternatively, the tote may be loaded with items by the operator when the order includes place task. In this example the initial task assigned is a place task, so operator 50a would receive a communication from robot 18a (originating from WMS 15a) about the item(s) to be loaded into a tote or platform on robot 18a and the operator would then communicate with robot 18a when the required item(s) has/have been loaded. The place order may also be communicated directly by the WMS 15a to the operator so that the tote may be pre-packed and ready to placed on robot 18a.

The robot will also receive from WMS 15a other tasks to be performed which, in addition to the place task assigned, form the order for the individual order session to be executed. The order includes the tasks, with task types as well as product SKU's for each task. The manner in which the tasks are aggregated and assigned by WMS 15a to a particular robot is described further below.

Once loaded with a tote including the items to be placed for the place task, robot 18a navigates to location B to execute its first assigned task in order 16a. The navigation approach used for placing items and for inventory management tasks is the same as described above with regard to FIGS. 6-8; namely, WMS 15a informs robot 18a of the product SKU and task type for each task. From the SKU, the robot 18a determines the bin number and corresponding fiducial ID. From the fiducial ID, the pose associated with the product SKU is determined and the robot navigates to the pose associated with each task.

At location B the robot 18a communicates to operator 50b the appropriate task and the items on which the task is to be performed. In this case, the first task is a place task so the robot 18a communicates to the operator 50b that the items picked up at station 100a are to be placed in a particular bin proximate location B. The operator performs that task and communicates to the robot 18a that the task has been completed.

Robot 18a then navigates to location C, which is the location of the next task to be performed in order 16a. At location C the robot 18a communicates to operator 50c the appropriate task and the items on which the task is to be performed. In this case the robot 18a communicates to the operator 50c the item(s) is to be picked from a bin or bins proximate location C and placed in the tote or otherwise on the robot 18a. The operator performs that task and communicates to the robot 18a that the task has been completed.

Next, Robot 18a navigates to location D where it communicates to operator 50d the next task and the items on which the task is to be performed. In this case robot 18a communicates to the operator 50d an inventory control task; namely, an item count. Operator 50d then counts the number of items in a specified bin and communicates the item count to the robot 18a indicating that the task has been completed.

Robot 18a then navigates to the final stop in this order 16a, which is location E, proximate station 100a. Robot 18a communicates to operator 50e that the items picked up at location C are to be removed from the tote or otherwise on the robot 18a and packed and shipped to a customer. The operator performs that task and communicates to the robot 18a that the task has been completed. Robot 18a is then free to receive its next order from order server 14a.

The status of the execution of the full order, including the individual steps, may be communicated to WMS 15a in order for the warehouse management system to track in real time the overall operation and status of activity within warehouse 10a. The warehouse management system 15a could also dynamically adjust the order of the individual robots 18a in order to improve efficiency.

WMS 15a may have a queue of tasks for each task type from which it can select and aggregate tasks to form individual orders to be assigned. The manner in which the tasks are aggregated and assigned by WMS 15a to a particular robot may be accomplished in various ways. One way that may be used is to have the aggregation and assignment driven by one of queues, e.g. the pick queue or the place queue. In other words, as a robot is inducted and an order is to be assigned, the system may start with the first pick task in the queue and from that an aggregate order having other tasks of different tasks types for the robot could be built based on predefined criteria.

For example, the predetermined criteria could be the location of the first pick task in the warehouse or the path to be taken to get to the first pick task. Other criteria associated with the pick task, may include the pick density (number of picks over a given time in an area of the warehouse) in the area of the pick task or along the path to the pick task, and the congestion (current number of robots/operators) at the location of the pick task or on the path to be taken by the robot to the pick task. WMS 15a will then review the queue of place orders as well as the queue of inventory management tasks and bundle one or more place tasks and one or more inventory managements tasks with the pick task based on the predetermined criteria, as described above.

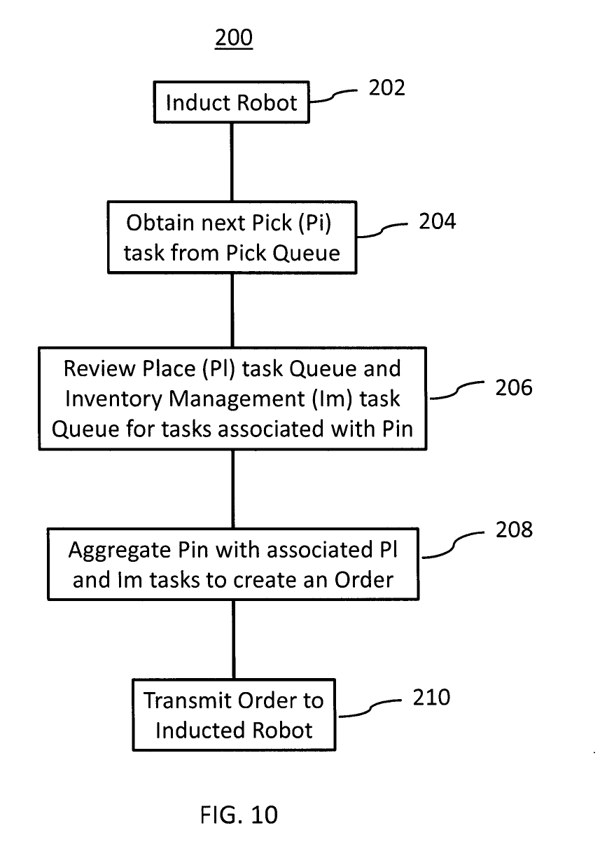

Flow chart 200, FIG. 10 depicts the order aggregation process according to an aspect of this invention. At step 202, an operator, such as operator 50a, FIG. 9, inducts a robot, such as robot 18a, at station 100a to begin an individual order session. At step 204 the highest priority pick (Pi) task is obtained from the pick task queue. The order of priority is typically based on required delivery date of the item(s) to the customer. The place (Pl) task queue and the inventory management (Im) task queue are reviewed at step 206 to identify tasks associated with Pi according to certain criteria, for example, the location of the first pick task, the path to be taken to get to the first pick task, the pick in the area of the pick task or along the path to the pick task, and the congestion at the location of the pick task or on the path to be taken by the robot to the pick task. At step 208, the pick task, Pi, is aggregated with the associated place tasks, Pl, and inventory management tasks, Im, identified in step 206 to create an order, such as Pi1, Pl1, Im1. There could be included in the order additional tasks such as Pi2, Pl2, Im2 . . . . The order is then transmitted to the robot for execution.

In the alternative, WMS 15a could begin with the first place task in the queue and from that an aggregate order for the robot including pick and inventory management tasks could be built based on an association between the place task and pick and inventory management tasks.

Having described the invention, and a preferred embodiment thereof, what is claimed as new and secured by Letters Patent is:

1. A method for executing an order to perform a plurality of tasks on items at locations throughout a warehouse space using a robot, the method comprising:
Receiving an order for the robot to execute a plurality of tasks, the order including for each task, a task type and an item associated with each task;
Navigating the robot to the locations in the warehouse space associated with each item; and
Executing at each location, the task type on the associated item;
wherein the task types for the order include picking, placing, and at least one inventory control task.

2. The method of claim 1 wherein the at least one inventory control task is selected from the group consisting of consolidating, counting, verifying, cleaning, and inspecting.

3. The method of claim 1 wherein each item is associated with a fiducial marker in the warehouse space, each fiducial marker located proximate its respective item.

4. The method of claim 3 wherein the step of navigating includes obtaining a fiducial identification associated with each item and correlating each said fiducial identification with a corresponding fiducial marker; and wherein the step of navigating further includes obtaining a set of coordinates representing a position of the fiducial marker in the warehouse associated with each item.

5. The method of claim 4 wherein the step of navigating includes navigating the robot sequentially to each set of coordinates in the warehouse corresponding to the fiducial marker associated with each of the items.

6. The method of claim 1 wherein the step of executing includes communicating by the robot to a human operator proximate each location, the task type and the item on which the task is to be performed.

7. The method of claim 6 wherein the step of executing further includes communicating by the human operator to the robot the completion of the task.

8. The method of claim 1 further including producing the order by a warehouse management system.

9. The method of claim 8 wherein the step of producing the order comprises:
Selecting one of a pick task or a place task from a task queue;
Selecting the other of the pick task or the place task from the task queue;
Selecting an inventory management task from the task queue;
wherein the other of the pick task or the place task and inventory the management task are associated with the selected pick task or place task according to predetermined criteria;
Aggregating the selected pick task, place task and inventory management task to produce the order; and
transmitting the order to the robot for execution.

10. A robot configured to execute an order to perform tasks on a plurality of items at locations throughout a warehouse space, the robot comprising:
A mobile base; and
A processor configured to:
Receive an order for the robot to execute a plurality of tasks, the order including for each task, a task type and an item associated with each task;
Navigate the robot to the locations in the warehouse space associated with each item; and
Execute at each location, the task type on the associated item;
wherein the task types for the order include picking, placing, and at least one inventory control task.

11. The robot of claim 10 wherein the inventory control task is selected from the group consisting of consolidating, counting, verifying, cleaning, and inspecting.

12. The robot of claim 10 wherein each item is associated with a fiducial marker in the warehouse space, each fiducial marker located proximate its respective item.

13. The robot of claim 12 wherein the processor is further configured to obtain a fiducial identification associated with each of item and correlate each said fiducial identification with a corresponding fiducial marker; and wherein processor is configured to obtain a set of coordinates representing a position of the fiducial marker in the warehouse associated with each item.

14. The robot of claim 13 wherein the processor is further configured to navigate the robot sequentially to each set of coordinates in the warehouse corresponding to the fiducial marker associated with each of items.

15. The robot of claim 10 wherein the processor is configured to cause the robot to communicate to a human operator proximate each location, the task type and the item on which the task is to be performed.

16. The robot of claim 15 wherein the processor is configured to allow the robot to receive communications from the human operator regarding the completion of each task.

17. The robot of claim 10 wherein the order is produced by a warehouse management system.

18. The robot of claim 17 wherein the order is produced by:
Selecting one of a pick task or a place task from a task queue;
Selecting the other of the pick task or the place task from the task queue;
Selecting an inventory management task from the task queue;
wherein the other of the pick task or the place task and inventory the management task are associated with the selected pick task or place task according to predetermined criteria;
Aggregating the selected pick task, place task and inventory management task to produce the order.

19. A method for executing an order to perform tasks on a plurality of items at locations throughout a warehouse space using a robot, the method comprising:
Receiving an order for the robot to execute a plurality of tasks, the order including for each task, a task type and an item associated with each task; wherein there are at least two different task types associated with the items;
Determining the locations in the warehouse space associated with each of items; wherein each of the items is associated with a fiducial marker located proximate the location of its respective item in the warehouse space; and wherein the step of determining includes obtaining a set of coordinates representing the location of the fiducial marker in the warehouse associated with each of the items;
Navigating the robot to each of said locations in the warehouse space by navigating to the coordinates of the fiducial marker in the warehouse associated with each of items; and
Executing at each location the task associated with the item corresponding to the location.

20. A robot for executing an order to perform tasks on a plurality of items at locations throughout a warehouse space using a robot, the robot comprising:
A mobile base; and
A processor configured to:
Receive an order for the robot to execute a plurality of tasks, the order including for each task, a task type and an item associated with each task; wherein there are at least two different task types associated with the items;
Determine the locations in the warehouse space associated with each of items; wherein each of the items is associated with a fiducial marker located proximate the location of its respective item in the warehouse space; and wherein the processor is configured to obtain a set of coordinates representing the location of the fiducial marker in the warehouse associated with each of the items;
Navigate the robot to each of said locations in the warehouse space by navigating to the coordinates of the fiducial marker in the warehouse associated with each of items; and
Execute at each location the task associated with the item corresponding to the location.
